(19) United States
(12) Patent Application Publication
(10) Pub. No.: US 2024/0015059 A1
(43) Pub. Date: Jan. 11, 2024

(54) METHOD AND SYSTEM FOR RANGE EXTENSION IN WIRELESS COMMUNICATION

(71) Applicant: NXP USA, Inc., AUSTIN, TX (US)

(72) Inventors: Hari Ram Balakrishnan, Chennai (IN); Sudhir Srinivasa, Los Gatos, CA (US); Rui Cao, Sunnyvale, CA (US); Hongyuan Zhang, Fremont, CA (US); Sergey Timofeev, Mountain View, CA (US); Rong Zhang, San Jose, CA (US); Priyanka Bansal, Lakheri (IN)

(21) Appl. No.: 18/347,769

(22) Filed: Jul. 6, 2023

Related U.S. Application Data
(60) Provisional application No. 63/368,572, filed on Jul. 15, 2022.

(30) Foreign Application Priority Data
Jul. 7, 2022 (IN) 202221039063
Feb. 28, 2023 (IN) 202341013547

(51) Int. Cl. H04L 27/26; H04L 27/20; H04L 5/00

(52) U.S. Cl. CPC H04L 27/26132; H04L 27/2085; H04L 5/0007

(57) ABSTRACT

A method and system for generating an extended range (ER) physical layer protocol data unit (PPDU) is disclosed. The PPDU has a legacy portion of the ER PPDU which comprises one or more of a legacy short training field (L-STF), a legacy long training field (L-LTF), and a universal signaling (U-SIG) field and an ER portion of the ER PPDU which is appended to the legacy portion. The ER portion comprises one or more repetitions of a ER short training field (ER-STF), a ER long training field (ER-LTF), a ER-signal (ER-SIG) field, and a ER data field. In an example, signals indicative of the one or more repetitions for a same field are combined by a receiver to increase a signal to noise ratio of a field.

### RELATED APPLICATION

This application claims a benefit of priority to Indian Provisional Application Number 202221039063, filed Jul. 7, 2022, U.S. Provisional Application No. 63/368,572, filed Jul. 15, 2022, and Indian Provisional Application Number 202341013547, filed Feb. 28, 2023, the contents each of which are incorporated herein by reference in its entirety.

### FIELD OF USE

This disclosure generally relates to wireless communication, and more particularly to range extension in wireless communication.

### BACKGROUND

In wireless communications, wireless devices, e.g., Access Points (APs) and client stations (STA), wirelessly transmit and receive PPDUs. As a number of devices increase and new services are supported by these devices, the wireless devices need to be able to transmit and receive signals over longer ranges. To extend the range that the PPDUs are transmitted and received, Institute of Electrical and Electronics Engineers (IEEE) 802.11ax and IEEE 802.11be define an extended range PPDU. The extended range PPDU improves on a reception range compared to a conventional PPDU but the range is still limited in 5 GHz and 6 GHz bands due to higher propagation losses and regulatory limits for power spectrum density and is still not compatible with practical usages. IEEE 802.11b also describes direct sequence spread spectrum (DSSS) communication to support an extended range, but the communication is limited to low-data rate communication which also is not compatible with practical usages.

### BRIEF DESCRIPTION OF THE DRAWINGS

The drawings are for the purpose of illustrating example embodiments, but it is understood that the embodiments are not limited to the arrangements and instrumentality shown in the drawings.

FIG. 1 is a block diagram of an example wireless local area network (WLAN) in accordance with an embodiment.

FIG. 2 is an example of the extended range (ER) physical-layer protocol data unit (PPDU) in accordance with an embodiment.

FIG. 3 illustrates example functions associated with single carrier-frequency division multiplexed transmission in accordance with an embodiment.

FIG. 4 illustrates an example of time domain repetition in accordance with an embodiment.

FIG. 5 is another example of the time domain repetition in accordance with an embodiment.

FIG. 6 is one example of a frequency domain repetition of one or more fields of an ER portion of the ER PPDU in accordance with an embodiment.

FIG. 7 is another example of a frequency domain repetition of one or more fields of the ER portion in accordance with an embodiment.

FIG. 8 illustrates an example of a hybrid time domain and frequency domain repetition in accordance with an embodiment.

FIG. 9 is an example flowchart that illustrates functions for generating the ER PPDU in accordance with an embodiment.

FIG. 10 is an example arrangement of the range extension circuit which generates the ER PPDU in accordance with an embodiment.

### DETAILED DESCRIPTION

The detailed description of the appended drawings is intended as a description of the currently preferred embodiments of the present disclosure, and is not intended to represent the only form in which the present disclosure may be practiced. It is to be understood that the same or equivalent functions may be accomplished by different embodiments that are intended to be encompassed within the spirit and scope of the present disclosure.

Embodiments disclosed herein are directed to an extended range (ER) physical layer protocol data unit (PPDU) which enables range extension while providing coexistence with legacy devices in wireless communication. The ER PPDU is transmitted by an AP device to a client device which is able to decode an extended range portion of the ER PPDU when the client device might not be able to decode a legacy portion of the ER PPDU. The ER PPDU includes the legacy portion and the extended range (ER) portion. The legacy portion of the ER PPDU comprises one or more of a legacy short training field (L-STF), a legacy long training field (L-LTF), legacy signal (L-SIG) field, repeated L-SIG (RL-SIG) field, a universal signaling (U-SIG) field, and in some examples include a transition signaling field. At least some fields of the legacy portion may be defined by IEEE 802.11be or 802.11ax in an example so that the legacy devices compliant with IEEE 802.11a/g/n/ac/ax/be have the capability to decode the legacy portion of new ER PPDU and perform corresponding clear channel assessment (CCA) for better coexistence with ultra high rate (UHR) ER devices. Based on a receiver not being able to decode the legacy portion of the PPDU, the receiver attempts to decode the ER portion. The ER portion of the PPDU which is appended to the legacy portion comprises one or more repetitions of one or more of a ER short training field (ER-STF), ER long training field (ER-LTF), an ER signal (ER-SIG) field, and a ER data field. The repetition may be in time, in frequency within a channel bandwidth, or both in time and in frequency. In an example, a time domain repetition of the ER-STF includes a polarity change of one or more waveforms representative of one or more bits of a binary sequence in the ER-STF and in symbols of the ER-LTF, and the ER-SIG field and ER data field are repeated by repeating a respective binary sequence in resource units (RUs) of symbols in accordance with a dual carrier modulation with duplication (DCM+DUP) with a 106 tone, 52 tone, or 26 tone resource unit (RU). The client device which receive the ER-portion combines signals of the one or more repetitions for a same field to increase a signal to noise ratio (SNR) of the one or more fields in the ER portion to facilitate the decoding. In an example, the repetition increases the SNR in a decoded signal by greater than 3 dB. Well known instructions, protocols, structures, and techniques have not been shown in detail in order not to obfuscate the description.

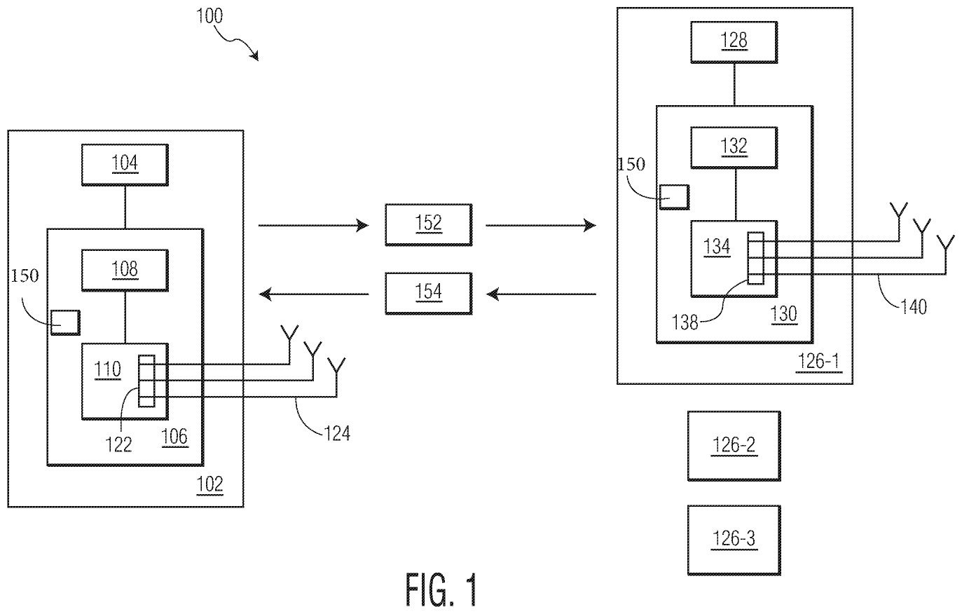

FIG. 1 is a block diagram of an example wireless local area network (WLAN) 100 in accordance with an embodiment. A wireless device in the form of an AP 102 includes a host processor 104 coupled to a network interface 106. The network interface 106 includes a medium access control (MAC) processing unit 108 and a physical layer (PHY) processing unit 110. The PHY processing unit 110 includes a plurality of transceivers 122 (e.g., transmitters and/or receivers) and the transceivers 122 are coupled to a plurality of antennas 124. Although three transceivers 122 and three antennas 124 are illustrated in FIG. 1, the AP 102 includes other suitable numbers (e.g., 1, 2, 4, 5, etc.) of transceivers 122 and antennas 124 in other embodiments. In one embodiment, the MAC processing unit 108 and the PHY processing unit 110 are configured to operate according to a communication protocol such as Institute of Electrical and Electronics Engineers (IEEE) 802.11 WiFi standard.

The WLAN 100 also includes one or more wireless devices in the form of a plurality of client stations 126. Three client stations 126 shown as 126-1, 126-2, and 126-3 are illustrated in FIG. 1, but the WLAN 100 may include other suitable numbers (e.g., 1, 2, 3, 5, 6, etc.) of client stations 126 in various scenarios and embodiments. At least one of the client stations 126 (e.g., client station 126-1) is configured to operate at least according to the communication protocol to communicate with the AP 102.

The client station 126-1 includes a host processor 128 coupled to a network interface 130 which includes a MAC processing unit 132 and a PHY processing unit 134. The PHY processing unit 134 includes a plurality of transceivers 138 and the transceivers 138 are coupled to a plurality of antennas 140. Although three transceivers 138 and three antennas 140 are illustrated in FIG. 1, the client station 126-1 includes other suitable numbers (e.g., 1, 2, 4, 5, etc.) of transceivers 138 and antennas 140 in other embodiments.

In various embodiments, the PHY processing unit 110 of the AP 102 is configured to generate and transmit data units 152 via the antenna(s) 124 over an air interface and the PHY processing unit 134 of the client station 126-1 is configured to receive the data units 152 via the antenna(s) 140 over the air interface. Similarly, the PHY processing unit 110 of the client device 126-1 is configured to generate and transmit data units 154 via the antenna(s) 140 and the PHY processing unit 110 of the AP 102 is configured to receive the data units 154 via the antenna(s) 124. In an example, the data units 152, 154 may be physical-layer data units (PPDU) for communicating data between the AP 102 and the client device 126-1 and the PPDU 152 (and fields therein) may be transmitted as a waveform in a downlink direction while the PPDU 154 (and fields therein) may be transmitted as a waveform in an uplink direction.

In embodiments, the AP 102 and one or more of the client stations 126 includes a respective range extension circuit 150 which defines an extended range format of the PPDUs 152, 154 to increase a range and/or a signal-to-noise (SNR) ratio associated with transmitting, receiving, and successfully decoding the PPDUs 152, 154 exchanged in the WLAN 100. The range extension circuit 150 may define a format of the transmitted ER PPDUs 152 154 to increase a range and/or signal-to-noise ratio (SNR) associated with transmission and reception of the PPDU 152, 154 and a process for transmitting and receiving the PPDU. In an example, functions of the range extension circuit 150 may be a resource of the network interface to support transmission and reception of the PPDU. In an example, the PPDUs 152, 154 may be an extended range (ER) PPDU as disclosed herein for communicating data between the AP 102 and the client device 126. Legacy standards may be adopted standards up to and including IEEE 802.11be (e.g., IEEE 802.11a/g/n/ac/ax/be) and non-legacy standards may be standards proposed after IEEE 802.11be such as WiFi8 while being backward compatible with the legacy IEEE 802.11 standard. In an example, the non-legacy standard may be modified to define the ER PPDU 152, 154 which includes a legacy portion with legacy fields of a legacy IEEE 802.11 standard decoded by a legacy device and an extended range (ER) portion with non-legacy fields of a non-legacy IEEE 802.11 standard decoded by a non-legacy device. The legacy portion includes fields compatible with the legacy IEEE 802.11 standard and the extended range portion has one or more fields compatible with the non-legacy IEEE 802.11 standard which in some examples are repeated in a time domain and/or duplicated in a frequency domain to increase a range and/or SNR ratio associated with transmission and reception of data in the extended portion of the data units 152, 154. In an example, the ER PPDU 152 may be a trigger frame which is transmitted by the AP device 102 and which is received by the client device 126 in a downlink direction. The range extension may allow the client device to decode the ER portion of the trigger frame at an extended range. Decoding is a process of determining a valid pattern of bits of the received PPDU referred to as decoded bits. In an example, the decoding may involve performing a parity check or CRC which determines whether the decoding is successful or is not successful. The trigger frame may solicit a response from the client device 126 which responsively transmit the packet 154 which is an uplink packet from the client device 126 back to the AP device 102 in an uplink direction.

In an example, one or more of the device 102, 126 may be implemented with circuitry such as one or more of analog circuitry, mix signal circuitry, memory circuitry, logic circuitry, and processing circuitry that executes code stored in a memory that when executed by the processing circuitry performs the disclosed functions, among other implementations. In an example, the implementation may be a system on a chip (SoC).

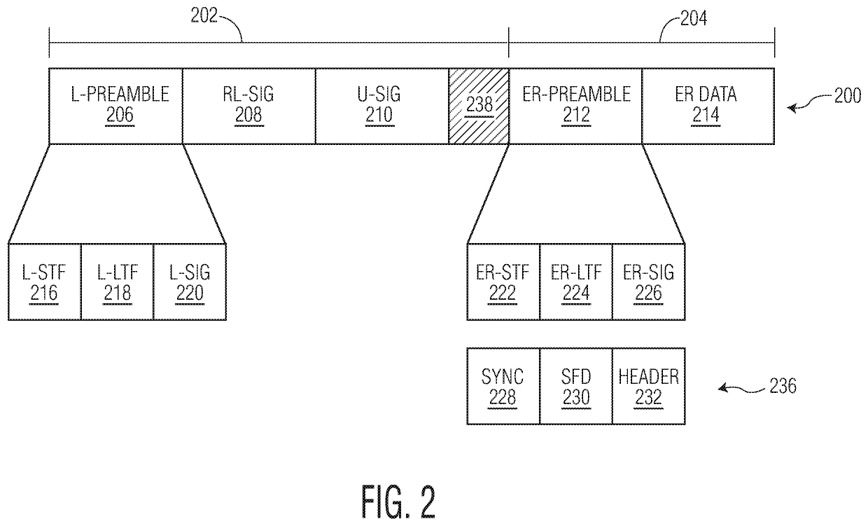

FIG. 2 is an example of the extended range (ER) physical-layer packet data unit (PPDU) 200 in accordance with an embodiment. The PPDU 200 may have a legacy portion 202 and an ER portion 204 which are transmitted by antenna as a waveform. The legacy portion 202 includes legacy fields which legacy 802.11 devices are able to decode for co-existence while the ER portion 204 may include one or more ER fields so that next generation devices such as WiFi 8 UHR devices are able to transmit and receive data in the ER portion 204 with increased range and SNR ratio. In an example, a bandwidth of the legacy portion 202 and the ER portion 204 is the same to provide co-existence with legacy devices.

The legacy portion 202 may define a legacy short training field (STF) 216 (L-STF), legacy long training field (LTF) 218 (L-LTF), and a legacy signal (SIG) 220 (L-SIG) field. The L-STF 216 is used to detect a starting of the PPDU or portion thereof and to establish orthogonal frequency division multiplexed/access (OFDM/A) symbol timing for data detection, i.e. frame acquisition and time synchronization. The L-LTF 218 is used for channel estimation/training for information detection. The channel estimation is a process of determining channel characteristics (e.g., a frequency response) of a channel which the PPDU is transmitted. The L-SIG field 220 includes information for data decoding and coexistence such as packet length (L-LENGTH), rate information, etc.

In an example, the L-SIG 220 may be repeated in time and the repetition is included in the repeated L-SIG (RL-SIG) field of the legacy portion 202 as a repeated L-SIG field (RL-LSIG) 208 such that the L-SIG 220 is repeated twice. The repetition may allow increased range and SNR associated with receipt of the SIG field 220. The U-SIG field 210 in the legacy portion 202 may include an indication of a version of the physical layer communication of IEEE 802.11 such as in a three-bit PHY identifier, an uplink/downlink flag, Basic Service Set (BSS) color, transmission (TX) opportunity (TXOP) duration, bandwidth, etc. Like the SIG field, the U-SIG field 220 may also be repeated twice in time for better reception. To also extend the range, a transmission power of a waveform of one or more of the L-STF 216 and the L-LTF 218 may be boosted to 3 dB.

To further extended the range, a transmission power associated with the L-STF 216 and L-LTF 218 could be boosted to greater than 3 dB and the L-SIG 220 and the U-SIG 210 may be repeated more than twice but these changes will create compatibility issues with legacy devices because of energy drop-off between when the legacy device receives the L-SIG 220 and receives the L-LTF 218, erroneous detection of the LSIG 220 and U-SIG 210 fields, and a high peak to average power ratio of the PPDU. The legacy portion 202 may be modulated on an orthogonal frequency division multiplexed (OFDM) signal which defines subcarriers for transmitting the fields of the legacy portion 202 and as a result range extension is also limited by a maximum peak to average ratio (PAPR) of the waveform representing the PPDU which IEEE 802.11 specifies. IEEE 802.11b defines a single-carrier binary sequence design which demonstrates range extension benefits over OFDM associated with 802.11 ax and 802.11 be. But the carrier is only defined for a 2.4 GHz band and does not co-exist with IEEE 802.11a such that the format cannot be extended into a 5 GHz and 6 GHz band without also causing backward compatibility issues for legacy devices.

In some examples, one or more transition symbols 238 may be optionally added after U-SIG 210 and before the ER portion 204 in the legacy portion 202. A symbol such as an OFDM symbol which spans a channel bandwidth may signal as a transition between U-SIG 210 and the ER portion 204 and has a predefined duration. The optional nature of inclusion in the PPDU 200 is illustrated by the cross-hatching. These symbol(s) can be after U-SIG 210. The non-legacy device needs to determine a receiver state machine based a U-SIG decoding CRC check. In the case that the U-SIG decoding fails, e.g., a CRC check does not pass, the wireless device needs to reset receive time domain parameters, like CFO and sample frequency offset (SFO) compensation, while ER preamble detection logic is still running. The transition symbol 238 may provide some buffer time such that the ER-preamble 212 will not arrive before the receive time domain parameters is reset. Thus, the ER preamble detection will not be affected by the status from the legacy preamble detection. In one example, the transition symbol is defined as a signaling field, similar to EHT-SIG as in IEEE 802.11be.

To achieve range extension, the legacy portion 202 is followed by the ER portion 204. By appending the legacy portion 202 to the ER portion 204, the PPDU 200 is able to co-exist with the 802.11 legacy devices. A PPDU length in octets indicated in the L-SIG field 220 is backward compatible with legacy devices to detect the PPDU 200 while the U-SIG field 310 provide both backward and forward compatibility. For example, the L-SIG LENGTH % 3==0, the U-SIG field 210 is modulated with binary phase shift keying (BPSK), and the U-SIG field 210 may indicate a “PHY version identifier” which indicates a PHY version. To signal the new ER format, a new value of “PHY version identifier” in the U-SIG field 210 can be used to indicate next generation PHY and a new “PPDU format” subfield can indicate the new ER format. In an example, the PPDU 200 may be limited for transmission over one spatial stream and modulation coding scheme (MCS) 0 or lower data rates. In an example, an unintended receiver which does not support a non-legacy standard can use indications of these fields to enter into a power save state in an example when the PPDU 200 is received and is not able to be processed, and set network allocation vector (NAV) values correspondingly to not transmit for at least a PPDU duration.

The ER portion 204 includes an ER preamble field 212 and an ER data field 214. The ER preamble field 212 further includes an ER-STF 222, ER-LTF 224, and ER-SIG field 226. The ER-STF 222 may be a predefined binary sequence used to detect start of the ER portion 204 and symbol timing for data detection, i.e. frame acquisition and time synchronization. In one embodiment, the ER-STF 222 consists of two parts: one binary sequence for synchronization followed by one binary sequence for STF ending and ER-LTF 224 may not be included. In another embodiment, the ER-STF 222 consists of one binary sequence followed by ER-LTF 224. If the receiver is not able to detect the legacy STF 216, the receiver will attempt to detect the ER-STF 222. The ER-LTF 224 defines a binary sequence for channel estimation/training by a receiver. In some examples, this field may be omitted for certain modulation schemes such as differential encoding for 802.11b. The ER-SIG field 226 includes information for data decoding. The ER-SIG 226 may include various parameters including rate, LENGTH, bandwidth, SERVICE field, and cyclic redundancy check (CRC) etc. defined by an ER-SIG binary sequence. Forward error correction (FEC) coding may be defined for this field to enhance reliability, e.g. binary convolutional coding (BCC). The ER data field 214 which follows the ER preamble field 212 includes a data payload defined by an ER-data binary sequence. Forward error correction (FEC) coding may be defined to enhance data decoding reliability, e.g. BCC or low density parity check code (LDPC). The ER portion 204 may be transmitted in various ways.

In one example, a waveform representative of the binary sequences of the ER portion 204 may be defined with a low peak-to-average ratio (PAPR) such that the transmitter can increase the maximum transmit power to increase communication range or enhance receiver reception reliability. Because the legacy preamble 202 may already have a high PAPR, a power amplifier associated with the transceiver which transmits the ER portion 204 may back off by ˜10 dB to keep all samples which are to be transmitted in a linear region to accommodate the PAPR. The power amplifier may transmit the ER portion 204 with some peak samples into a non-linear region for range extension and an ER spectrum growth due to the non-linearity may result in a lower PAPR, close to 0 dB depending on binary sequence design. In an example, the ER portion 204 may be transmitted with a power similar to a peak power of the legacy preamble 200 with ˜10 dB gain, but in some cases, an increase in transmit power may be limited by a power spectral density. In another example, the transmit power of a waveform of the ER portion 204 may be set to a power boost such as 3 dB or the transmitter may set a power boost based on a historical transmit power range.

The binary sequence of the ER-STF 216 may be modulated on a time domain waveform. Time domain modulation is defined as varying a modulation of a waveform over time. The binary sequence of the ER-LTF 222, ER-SIG 224, and ER data field 226 may be transmitted based on single carrier (SC) time-domain multiplexing (TDM). A binary sequence may be directly modulated on a time domain waveform to generate different time domain signals for different binary sequences and additional spreading can be applied, e.g. 802.11b direct sequence spread spectrum (DSSS). In some examples, the ER preamble 212 may be formatted in accordance with a 802.11b PPDU format 236 to facilitate the SC TDM transmission. The format 236 includes a sync field 228, a start frame delimiter (SFD) 230, and a header field 232. The sync field 228 and SFD 230 may function as the STF 222 and LTF 224. The header 232 may include various parameters of the ER-SIG field 226 including signal rate, LENGTH, BW, SERVICE field, and CRC, etc. The binary sequences of the fields may be modulated using differential binary phase shift keying (DBPSK) or differential quadrature PSK (DQPSK) with 11-chip Barker code spreading to encode bits and a chip rate may be reduced to 10 MHz to match a chip rate associated with orthogonal frequency division multiplexing (OFDM) defined by 802.11 for better spectrum compliance. To further extend the range, the SYNC field 228 can define a longer sequence, e.g. double the length to 256 bits. The SFD field 230 can also define a longer sequence, e.g. double the length to 32 bits. The header field 232 may also be encoded with BCC rate-1/2. The data field 214 in this example may add a BCC or LDPC to enhance decoding reliability and, in some examples, LDPC encoding can be simplified without puncturing and shortening. Pilot signals which are synchronization reference signals may also be added for CFO (carrier frequency offset) and CPE (carrier phase error) estimation in the ER data field 214.

In another example, the modulation of one or more of the fields in the ER-preamble 212 may be based on a single carrier (SC) frequency-domain multiplexing (FDM). Frequency domain multiplexing is defined as loading binary sequences to be transmitted onto subcarriers in a frequency band versus time domain signals, where different frequency bands may be assigned to different wireless devices. The ER-STF 222 may be transmitted with one of the 802.11b DSSS, a zero correlation zone (ZCZ) spreading sequence, or a Golay sequence (defined in 802.11ad/ay). The ER-LTF 224 may include a predefined binary sequence to estimate a channel of each subcarrier and transmitted in a manner similar to the ER-STF 222. The SIG field 226 and the data field 214 may be transmitted with SC-FDM. An LTF1 subfield of ER-LTF 224 may be added before the SIG field 226 to indicate information to demodulate SIG content and an LTF2 subfield of the ER-LTF 224 may be added to indicate information to demodulate ER data 214 content. The information may indicate a tone mapping and the LTF2 may be included in the ER-LTF 224 when a tone mapping of the subcarriers on which a binary sequence of the information are loaded and/or a bandwidth of the ER data field 214 is different from the SIG field 226. The tone mapping may be a process of selecting subcarriers in a set of subcarriers to transmit the binary sequence, where a subcarrier or tone is a defined frequency or frequencies in a channel bandwidth such as a 20 MHz channel having an amplitude and a phase. In an example, a bit or bits of the sequence may be modulated on the tone such as by binary phase shift keying (BPSK) or quadrature phase shift keying (QPSK) in an example to form a waveform.

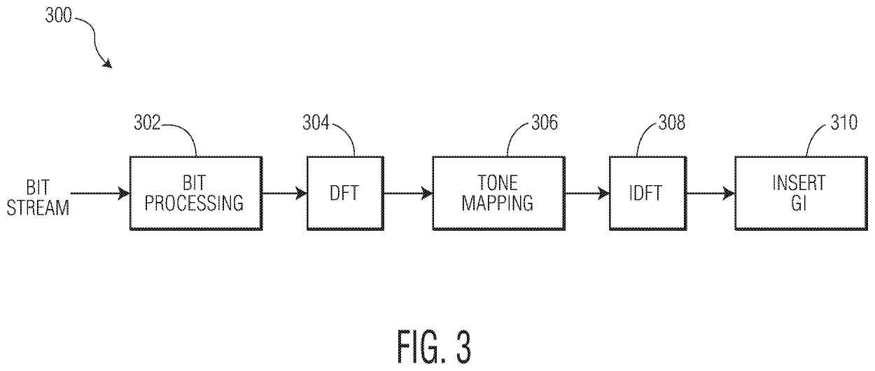

FIG. 3 illustrates example functions 300 associated with SC-FDM transmission of the ER-SIG field 226 and ER data field 214 in accordance with an embodiment. The functions 300 include bit processing 302 a binary sequence associated with a field of the PPDU, a discrete Fourier transform (DFT) 304, a tone mapping 306, an inverse DFT (IDFT) 308, and guard band insertion 310. At 302, the bit processing 302 may perform one or more of encoding, scrambling, and/or modulation of a binary sequence of a field in a time domain. At 304, a DFT of the processed binary sequence of the ER-SIG field 226/ER data field 214 may be generated followed by a tone mapping 306. The tone mapping 306 may populate the processed information bits in the frequency domain onto the subcarriers which spans a channel bandwidth such as a 20 MHz channel. Further, the population onto subcarriers may include mapping the processed binary sequence in the frequency domain to a resource unit which defines a plurality of tones for carrying the data. The tones may be contiguous or distributed. In an example, the bit processing 302 may perform a precoding of the information bits prior to the tone mapping 306 to reduce a peak to average ratio (PAPR) of a waveform prior to transmission. The IDFT 308 may generate a SC-FDM symbol which spans a channel bandwidth and the guard band insertion 310 may insert guard intervals to separate the symbols from interference. SC-FDM can be easily extended to a multiple user case, where each user is assigned to a subset of tones in the resource unit, i.e., each wireless device modulates its data (after DFT) onto different set of tones to facilitate extending range for uplink (UL) transmissions to multiple clients. For SC-FDM(A) mode, in one variant, the ER-SIG field 226 may be transmitted with SC-TDM, while the ER data field 214 may be transmitted with SC-FDM.

A tone map for the ER-SIG field 226 and ER Data field 214 transmitted using SC-FDM may be arranged as a 20 MHz ER PPDU: ER-SIG field 226 and ER Data field 214 can be defined as one or more of a 11a/g tone plan, e.g., 64-point FFT with 48 loaded data tones and 4 pilot tones, a 11n/ac 20 MHz tone plan, e.g., 64-point FFT with 52 loaded data tones and 4 pilot tones, or a 11ax/be 20 MHz tone plan, e.g., 256-point FFT with 234 loaded data tones and 8 pilot tones. The tones may be subcarriers with a predefined frequency to carry indications of bits in fields of the PPDU 200.

In another example, a wider bandwidth ER PPDU may be defined for a spectrum with a low power spectral density (PSD) requirement, e.g. 6 GHz low power indoor (LPI) operation. The ER-preamble 212 may be transmitted in a 20 MHz bandwidth. To accommodate coexisting with wireless devices with different operating bandwidths, a wide bandwidth ER preamble 212 may be defined based on repetition of the 20 MHz ER-preamble 212 across entire signal BW, e.g., 80 MHz, or a per-20 MHz tone polarity change can be applied to a phase of a tone which is waveform modulated with one or more bits of a binary sequence in the repetitions of the ER-preamble 212. The polarity change of −1 may change the phase of a waveform by 180 degrees while a polarity change of 1 may not change the phase of a waveform by 180 degrees. The changes in polarity may be known to the receiver to remove the polarity changes during a decoding process. The term repetition, repeated, and similar variations as used herein with respect to a field means that tones of two fields are the same after any applied polarity is removed.

In another example, the binary sequence of one or more fields of the ER portion 204 may be further repeated to improve communication range. Further, a binary sequence of ER portion 204 may be defined as a waveform with OFDM modulation. The repetition may be in a time domain or in a frequency domain. In an example, the repetition (also referred to as duplication) may be a repetition of one or more orthogonal frequency division multiplexed/multiple access (OFDM/A) symbols in time with a same binary sequence, a repetition in frequency of a same binary sequence in one or more orthogonal frequency division multiplexed/multiple access (OFDM/A) symbols, or a repetition in time and frequency.

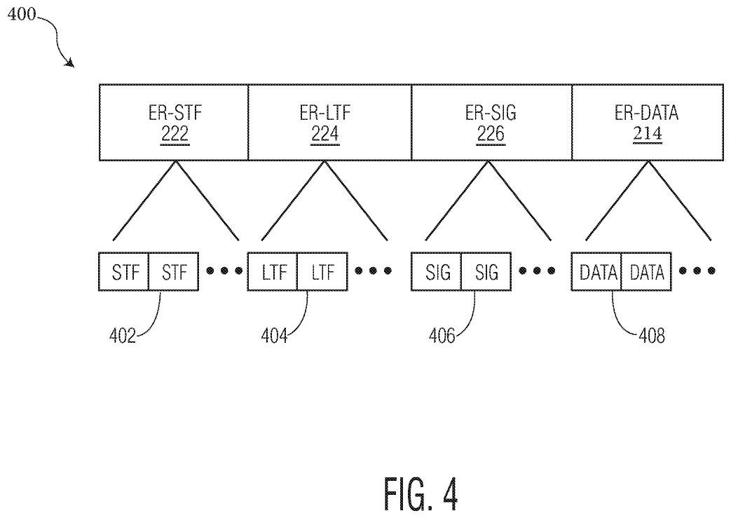

FIG. 4 illustrates an example of time domain repetition 400 in accordance with an embodiment. The repetition of ER-STF 222 may include repeated STF 402, the repetition of ER-LTF 224 may include repeated LTF 404, the repetition of ER-SIG field 226 may include repeated SIG field 406, and the repetition of ER data field 234 may include repeated ER data 408 in a time domain within a 20 MHz or larger bandwidth. The repetition may be one or more times in an example, and an example of which is shown as two repetition in the time domain repetition 400. In an example, reference to the ER-STF 222, ER-LTF 224, ER-SIG 226, and ER-Data 214 as described herein is not necessarily limited to one instance of the field and can also refer to repetition or multiple instances of the field in accordance with described embodiments. The receiver may perform a time domain combining of signals representing the bits in the repeated fields such as averaging process to obtain a better SNR.

In an example, an STF 402 is a function of a STF_BASIS of 0.8 us which an STF base binary sequence such that (STF 1, . . . , STF N)=f(STF_BASIS(0.8 microseconds (us))) where N=2 in the illustrated example. The STF 402 may represent a repetition based on the STF_BASIS. In some examples, the repetition of the ER-STF 222 may include two or more repetitions of the STF_BASIS. In an example, a repetition of the STF 402 may be further based on repetition of STF_BASIS with a polarity change. As an example, STF 402 which is 4 us=[STF_BASIS*Polarity(1), STF_BASIS*Polarity(2), STF_BASIS*Polarity(3), STF_BASIS*Polarity(4), STF_BASIS*Polarity(5)] and with N=6, the polarity is [STF1, STF2]=[STF3, STF4]=[STF5, STF6] and the polarity of P=[1, −1, −1, 1, −1, 1, −1, 1]. The polarity change indicates a change in phase of one or more periods of a waveform of the STF_BASIS, e.g., exp(1i*θ) where i is the polarity of −1 (−180 degree phase change) or +1 (+180 degree phase change). In an example, the ER-STF 222 may have a duration longer than 4 us or 8 us to improve carrier sensing. Further, a variation in polarity improves an accuracy of the short training estimation. The repetition of the ER-STF 222 may also be power boosted with a power boost of 3 dB in an example. The STA or AP which is not able to detect the L-STF 218 may be arranged to detect the ER-STF 222.

In an example, a duration of the STF_BASIS may be same as a duration of the L-STF 218 such as 0.8 us or in another example 1.6 us. The option of the non-0.8 us period may be designed so that a maximum carrier frequency offset (CFO) is able to be estimated, e.g. 1.6 us period can estimate CFO within 312.5 kHz, which is greater than a maximum CFO of 200 kHz (40 ppm@5 GHz) or ˜300 kHz (40 ppm@6 GHz band). The option of a non-0.8 us period also has the benefit of lowering a false trigger by a legacy device, without affecting devices which are able to receive the PPDU 200

The repetition of the ER-LTF 224, ER-SIG 226, and ER data field 21 may comprise repetition of a respective base binary sequence which defines a respective plurality of bits. For example, the ER-LTF 224 may include a time-domain repetition of an ER-LTF base binary sequence to form LTF 404. As another example, the repetition of the ER-SIG 226 may include a time-domain repetition 406 of an ER-SIG base binary sequence to form SIG 406. As yet another example, the repetition of the ER data field 214 may include a time-domain repetition 408 of an ER data base binary sequence to form ER data 408. In an example, a waveform representing a repetition of the ER-LTF 224 may further have a 3 dB power-boost. A number of repetitions of the ER-STF, ER-LTF, ER-SIG field, and ER-data field may be the same or different across fields and a receiver may perform time-domain combining of waveforms indicative of a base binary sequence to gain a better SNR.

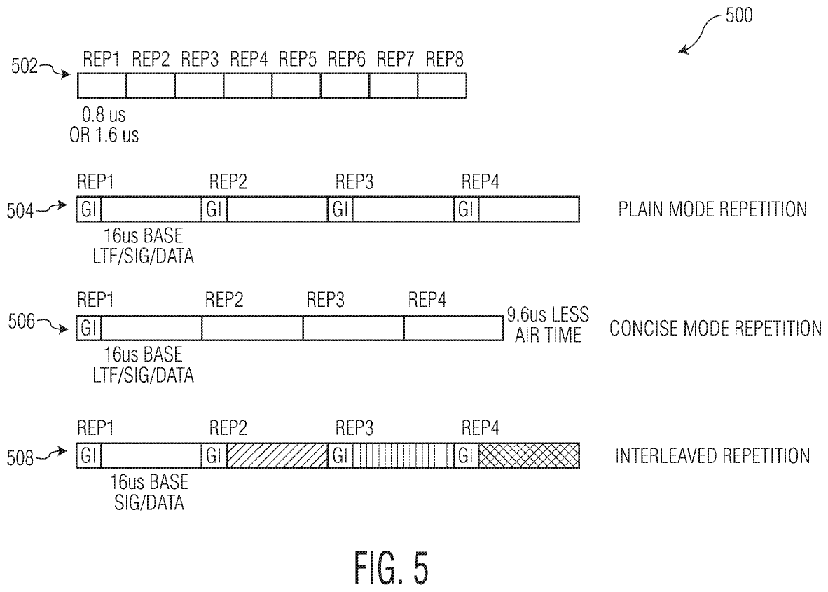

FIG. 5 is an example of various options 500 of the time domain repetition of the ER-STF 222, ER-LTF 224, ER-SIG field 226, or ER data field 214 in accordance with an embodiment. A function of the STF BASIS may be repeated in time shown by option 502 for ER-STF 222. In an example, the base binary sequence of the ER-STF 222 may have a 0.8 us period or a non-0.8 us period such as 1.6 us for each repetition. ER-STF 222 can further have a 3 dB power-boost of its waveform. In an example for repeated ER-LTF 224, ER-SIG field 226, or ER data field 214, the respective base binary sequence may be repeated in time with a guard interval in each repetition shown by option 504 which is a plain mode or a concise mode where the guard interval is only at a first repetition to shorten a transmission time shown by option 506. The guard interval may be a duration of time (e.g., 0.8 us, 1.6 us, 3.2 us) which separates the instances of indication of the binary sequences. The concise mode has the benefit of shortening an air-time compared to when a guard interval is associated with each repetition without penalizing the performance. For repeated ER-LTF 224, ER-SIG field 226, and ER data field 214, the respective base binary sequence may be 16 us. Further, for ER-LTF, time-domain repetition has the benefit of improved SNR, and also allows multiple rounds of CFO estimation. In plain mode, 1^{st} round CFO estimation can have an auto-correlation lag of 16 us and 2^{nd} round CFO estimation can have an increased auto-correlation lag for finer CFO estimation. In an example, the base binary sequences for the repeated ER-SIG field 226 and ER data field 214 may be bit interleaved or tone interleaved copies as shown by option 508 for the ER-SIG field 226 and ER data field 214 where the different cross hatching indicates different interleaving patterns create reliability of decoding in presence of burst errors. In an example, BCC interleaving may be used to interleave bits output by an encoding process prior to the encoded bits being mapped to tones in a constellation of tones for transmission or LDPC tone mapping may be used to interleave tones output after mapping encoded bits to the constellation of tones. In an example, the type of interleaving may be known to a receiver or indicated by signalling to the receiver in the L-SIG field 220 or ER-SIG field 226. Further, the interleaving may reduce spectral growth due to direct copy repetition to allow for a higher transmit power. The term repetition or repeated as used herein with respect to a field also means that tones of two fields are the same after any applied interleaving is removed.

In an example, time-domain repetition can be used to extend the reach of a null data PPDU (NDP). The NDP may have a universal preamble and an ER portion with a ER-STF and ER-LTF but there may be no ER data or ER-SIG in an ER portion. In this case, both ER-STF and ER-LTF need to be repeated in time. The number of repetitions in the NDP may or might not be the same as that of the ER PPDU 200. One example is 4× repetition of the ER-LTF in the ER NDP and 4× repetition of the ER-LTF in the ER PPDU. Another example is 2× repetition of the ER-LTF in the ER NDP and 4× repetition of the ER-LTF in the ER PPDU. ER-LTF in the ER NDP may further support 3.2 us GI regardless of its type being 2× or 4×. For example, the support could be 2× repetition of the ER-LTF with 3.2 us GI, in addition to 2× repetition of the ER-LTF with 0.8 us GI, 2× repetition of the ER-LTF with 1.6 us GI, 4× repetition of the ER-LTF with 3.2 us GI. A period of an STF binary sequence of the ER-STF in the ER NDP which is repeated may be 0.8 us or non-0.8 us based and the time domain repetition of the ER-LTF in the NDP may be in plain or concise mode, as previously disclosed.

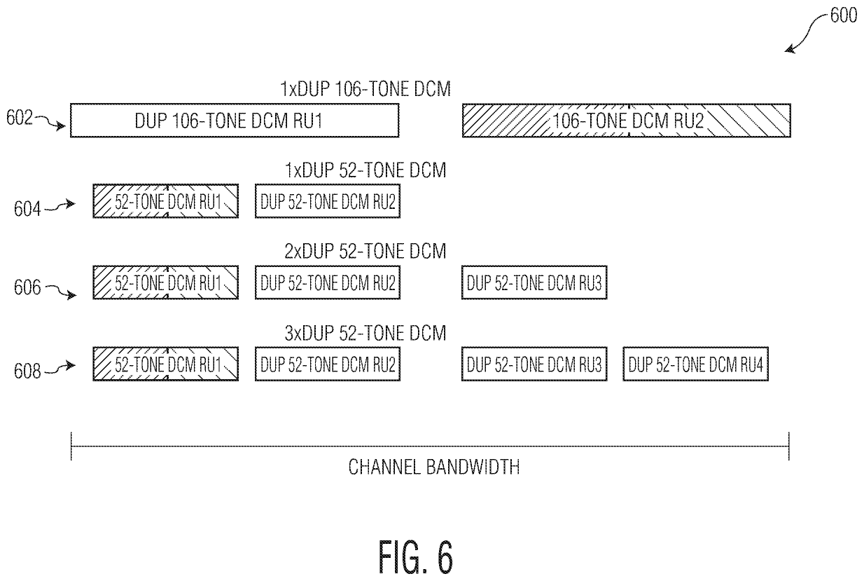

FIG. 6 is one example of a frequency domain repetition 600 of one or more fields of the ER portion 204 in accordance with an embodiment. Frequency domain repetition involves transmitting repeated data by modulating the repeated data on subcarriers in a channel bandwidth for transmission over a frequency spectrum rather than in the time domain repetition repeating signals which carry the data over time. For example, a 20 MHz bandwidth channel may have subcarrier tones identified by indices −122 to +122 on which data may be modulated and a resource unit (RU) may define a plurality of subcarrier tones. IEEE 802.11ax defines various frequency-domain repetition modes such as a 242-tone dual carrier modulation (DCM) and 106-tone DCM in 20 MHz. DCM, as the name implies, modulates same information on a pair of subcarriers m and n. Further, a 52-tone DCM is proposed, where for any given 52-tone RU, DCM is used on its constituent two 26-tone RUs. For example, 52-tone RU [−121:−70] is composed of 26-tone RU1 [−121:−96] and 26-tone RU2 [−95:−70], on which DCM is applied. MCS summarizes and categorizes Wi-Fi parameters such as modulation, coding scheme, guard interval, and channel width. In addition, a modulation coding scheme 14 (MCS14) defined in 802.11be specifies a duplicated DCM (BPSK-DCM-DUP) for bandwidth beyond 80 MHz. The frequency domain repetition 600 may include repeating or duplicating a base binary sequence of a field to be repeated on different RUs in a frequency domain and within a channel bandwidth. In an example, the frequency domain repetition 600 is based on a duplication (DUP) and dual carrier modulation (DCM) in accordance with an embodiment. The base binary sequence associated with one of the ER-SIG field 226 and ER data field 214 may be carried in tones of an RU and the binary sequence is then duplicated one or more times in the channel bandwidth over one or more RUs to repeat the fields.

A full band DUP mode 602 is proposed where a 1×DUP 106-tone DCM mode indicates to duplicate a binary sequence of a 106-tone DCM RU1 to a 106-tone DCM RU2 in a MHz band and 3×DUP 52-tone DCM mode 608 indicates to duplicate a binary sequence of a 52-tone DCM RU1 from its assigned 52-tone RU1 to three 52-tone DCM RUs in a 20 MHz band. A partial band DUP is also proposed where a 1×DUP 52-tone DCM mode 604 indicates to duplicate a binary sequence of a 52-tone DCM RU1 from its assigned 52-tone RU1 to any one of three 52-tone RUs within a 20 MHz band or a 2×DUP 52-tone DCM mode 606 to indicate to duplicate a binary sequence of the 52-tone DCM RU1 from its assigned 52-tone RU1 to any 2 of three 52-tone RUs within a 20 MHz band. The different cross hatching of an RU indicates bits of an initial DCM of an RU which is duplicated by dual carriers and the lack of cross hatching of an RU indicates a DCM duplication of bits of the initial DCM in another RU.

In an example, the SIG base binary sequence may be carried in an RU and encoded as an orthogonal frequency division multiplexed (OFDM) symbol associated with 802.11 and the ER-SIG 226 may include 4 repetition of the RU in a 106-tone RU DCM+DUP transmission to form a symbol in a channel bandwidth. In an example, a rate 1/2 BPSK with BCC encoding is used for the ER-SIG 226 field. In an example, the SIG binary sequence of the ER-SIG field 226 may have 25 bits which is transmitted as 52 data tones in an RU.

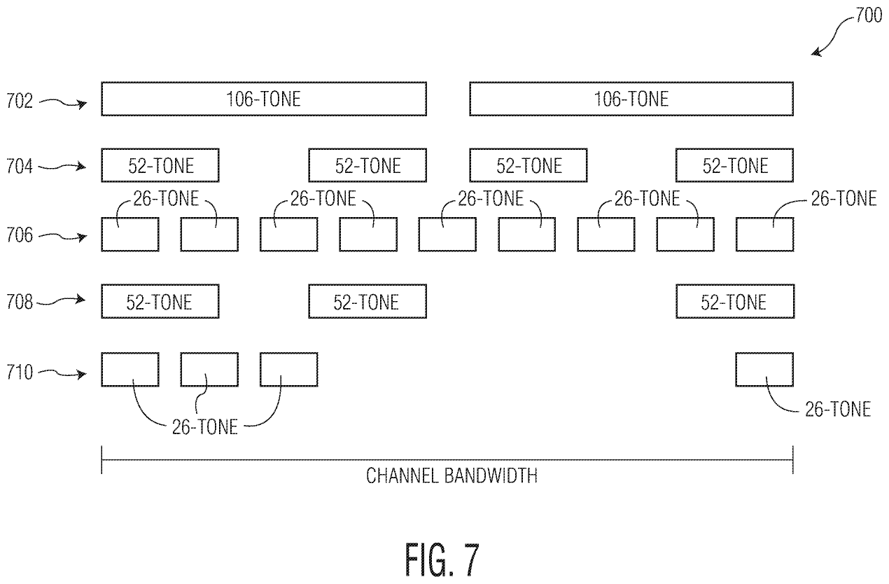

FIG. 7 is another example of a frequency domain repetition 700 of one or more fields of the ER portion 204 in accordance with an embodiment. In an example, the fields may be the ER-SIG 226 and ER data fields 214. The repetition may be based on RU repetition in a full band such as 20 MHz or a partial band where the RUs may not span the entire 20 MHz channel bandwidth. In an example, an RU repetition 702 may be a full band 106-tone RU repeated 2 times in the 20 MHz channel bandwidth. In another example, an RU repetition 704 may be a full band 52-tone RU repeated 4 times in the 20 MHz channel bandwidth. In yet another example, an RU repetition 706 may be a full band 26-tone RU repeated 9 times in the 20 MHz bandwidth. In yet another example, an RU repetition 708 may be partial band 52-tone RU is repeated less than 4 times in the 20 MHz channel bandwidth. For partial band, the repetition may or may not be contiguous, e.g. 52-tone RU repetition of 3 times can be RU1, RU2 and RU4 in the channel bandwidth. In yet another example, the RU repetition 710 may be a partial band 26-tone RU repeated less than 9 times in the 20 MHz channel bandwidth. For partial band, the repetition may or may not be contiguous, e.g. 26-tone RU repetition of 3 times can be RU1, RU2 and RU4 in the channel bandwidth. In an example a 106-tone RU repetition is different from 242-tone DCM and a 52-tone RU repetition is different from 106-tone DCM+DUP. In general, a number of repetitions may be different for DCM+DUP versus RU repetition. For example, a number of repetitions associated with 26-tone RU repetition is not the same as 52-tone DCM+DUP, e.g. 26-tone RU repetition of 3 times is not achievable by 52-tone DCM+DUP (4 repetitions). In some cases, they are the same, e.g. a number of repetitions associated with 26-tone RU repetition of 8 times excluding central RU is the same as 3×DUP 52-tone DCM (8 repetitions).

In an example, a 20 MHz channel may have two 106-tone RUs where data in each RU is transmitted using a dual carrier modulation (DCM) and RU1 is phase rotated compared to RU2 with tone indices ranging from RUL [−122:−17] and RU2: [17:122]. The phase rotation (exp(1i*θ(k))) is applied to a tone of one of the RU (e.g., every other RU) and known by a receiver, k being tone index in an RU. The phase rotation is applied to optimize for PAPR and avoids exact duplicated signal being transmitted. Further, the 106-tone RU may have eight pilot tones between the RUs: [−16, −12, −8, −4, 4, 8, 12, 16] of the central 26-tone RU [−16:−4, 4:16] and eight tones at pilot indices [−116, −90, −48, −22, 22, 48, 90, 116] for maintaining synchronization. In an example, the additional pilot tone indices need not be limited to these 8 tones and can utilize all or some sub-set of tones among the indices [−16 to −4, 4 to 16] and a total number of pilots per OFDM symbol may be equal to 16 or more. In an example, the pilots may support better common phase error (CPE) estimation in ER-SIG 226 and ER data 214. For 52-tone DCM and its DUP, pilots may be added in the central 26−tone RU [−16:−4, 4:16] and null tones [−122, −69, 69, 122]. For example, 16 pilots can be [422, −16, −14, −12, −10, −8, −6, −4, 4, 6, 8, 10, 12, 14, 16, 122]. The null tones are certain tones which data is not modulated on and serves as a guard band in a frequency domain. In an example, pilots can be added in a central 26-tone RU for 106-tone RU repetition, in a central 26-tone RU and null tones for 52-tone RU repetition, in null tones and central 26-tone RU if unused for 26-tone RU repetition, and unused/unloaded tones of an RU that would otherwise carry information as examples.

To support frequency-domain repetition, a symbol forming a repetition of ER-LTF 224 may be modified based on the null tones in an RU. The first option is that the LTF binary sequence follows the “OFDMA” arrangement, i.e., the values of an original base LTF sequence (e.g., 4× high efficiency (HE) LTF (HE-LTF) defined by IEEE 802.11) are set to zero in the ER-LTF 224 if they are assigned to null tones subcarriers. For example, for 1×DUP 106-tone DCM with 8 extra pilots in [−16, −12, −8, −4, 4, 8, 12, 16], the null subcarriers are [45,−14,−13,−11,−10,−9,−7,−6,−5,−3,−2,2,3,5,6,7,9,10,11,13,14,15]. For example, for 3×DUP 52-tone DCM with 16 extra pilots in [422, −16, −14, −12, −10, −8, −6, −4, 4, 6, 8, 10, 12, 14, 16, 122], the null subcarriers are [−69,−15,−13,−11,−9,−7,−5,−3,−2,2,3,5,7,9,11,13,15,69]. The second option is that the LTF binary sequence remains the same as the original base LTF sequence, where values of an original base LTF sequence (e.g. 4× high efficiency LTF (HELTF) defined by 802.11) assigned to null tones may not be used for channel estimation or still carry out channel estimation for smoothing purpose. As a result of duplication or repetition, frequency-domain PAPR reduction may be implemented. For example, a phase rotation to tones of RU associated with each duplicated/repeated copies may be performed or a scrambling or interleaving is performed in frequency domain.

In an example, the repetition could also be in both a time domain and frequency domain.

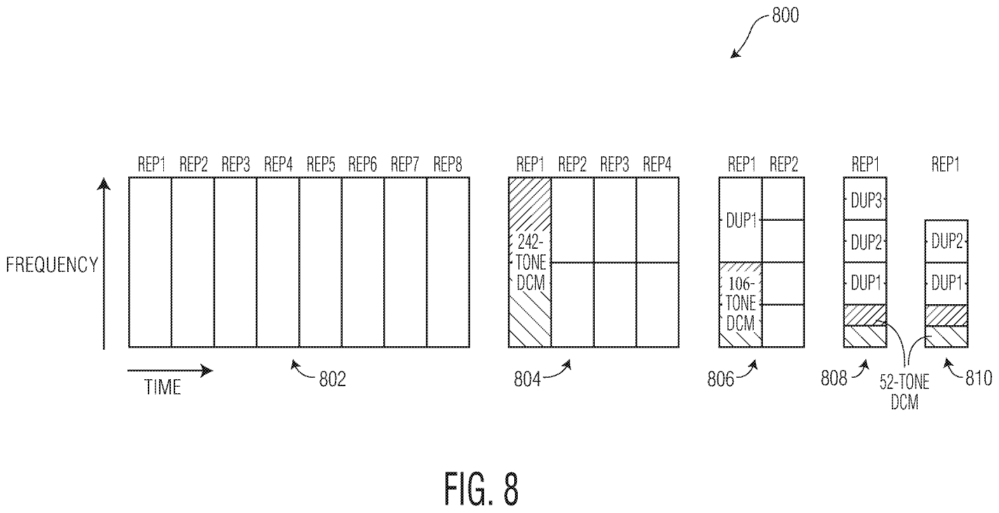

FIG. 8 illustrates an example of a hybrid time domain and frequency domain repetition 800 in accordance with an embodiment. Hybrid repetition is applicable for some fields in the ER PPDU 200, e.g., ER-SIG field 216, ER data field 214. For each base binary sequence for ER-SIG field 216 and ER binary sequence for data field 214, the repetition can be N time domain (TD) repetition 802 in plain (direct or interleaved) or concise mode with no frequency domain (FD) repetition where N=8; M TD repetition 804 in plain (direct or interleaved) or concise mode with 242-tone DCM (M=N/2 making the total repetitions=N); M TD repetition in plain (direct or interleaved) or concise mode with 1×DUP 106-tone DCM (M=N/4 making the total repetitions=N) 806; M TD repetition in plain (direct or interleaved) or concise mode with 3×DUP 52-tone DCM (M=N/8 making the total repetitions=N) 808; or M TD repetition in plain (direct or interleaved) or concise mode with 1×DUP/2×DUP 52-tone DCM (not shown). Each repetition may carry one RU. With the hybrid time domain and frequency-domain repetitions, more symbols may be needed, since the bits per symbol is reduced. The number of time-domain repetitions and frequency-domain repetitions can be different for the ER-SIG field 226 and ER data field 214.

In an example, the SIG binary sequence may be transmitted using 106-tone RU DCM+DUP transmission in a symbol and the symbol repeated twice such that a same information is sent eight times (4 repetitions and two symbols) based on the SIG binary sequence in the ER-SIG field 226. In an example, the fields of the ER-SIG 226 are illustrated in Table 1:

TABLE I

| Field value | #bits | Possible values |
|---|---|---|
| MCS | 2 | {106 DUP, 106 DUP with 2 symbol repetition, |
| | | Reserved} |
| Length | 11 | Length of the PSDU in octets |
| FEC | 1 | BCC or LDPC |
| BF | 1 | Whether the PPDU is beamformed or not |
| Reserved | 4 | — |
| Tail bits | 6 | All zero |

and the ER-SIG field 226 may have two repeated symbols. Also in some examples, interleaving may be applied on every alternate symbol of the repetition such that for the two symbols repeated one of the repeated symbols is interleaved. For example, one of the repeated symbol will use BCC interleaver/LDPC tone interleaving while the other symbol does not.

In an example, one or more of the LTF base binary sequence in the ER-LTF 224 and the base binary sequence in the ER data field 214 of the PPDU 200 may be transmitted in a manner similar to the ER-SIG field 226. The repetition may generate an effective gain in transmitted symbols. In an example, a waveform of each symbol in the ER-LTF 224 may have a 3 dB power boost and form eight repetitions. In an example, the ER-LTF 224 may include a number N of symbols. In an example, N may be greater than a number of spatial streams transmitted by the AP 102 to a single client device 126 but further limited to twice a number of spatial streams.

In an example, the binary sequence for transmitting the ER portion 204, e.g., ER-STF 222, ER-LTF 224, and ER-SIG 226 may be an OFDM binary sequence defined by 802.11. The ER-portion may be transmitted in a frequency domain. Further, a spacing of tones in a 20 MHz channel may be downclocked so that tones on which the ER portion 204 is modulated is in a smaller bandwidth. For example, the ER portion 204 may be transmitted in a 20 MHz/N band to produce a narrow band signal (where N is greater than one) and a wireless device which receives the narrow band signal may use a narrow band filter to recover the binary sequence with high signal-to-noise ratio (SNR). In some examples, a wireless device may preassign different narrow bands to different users.

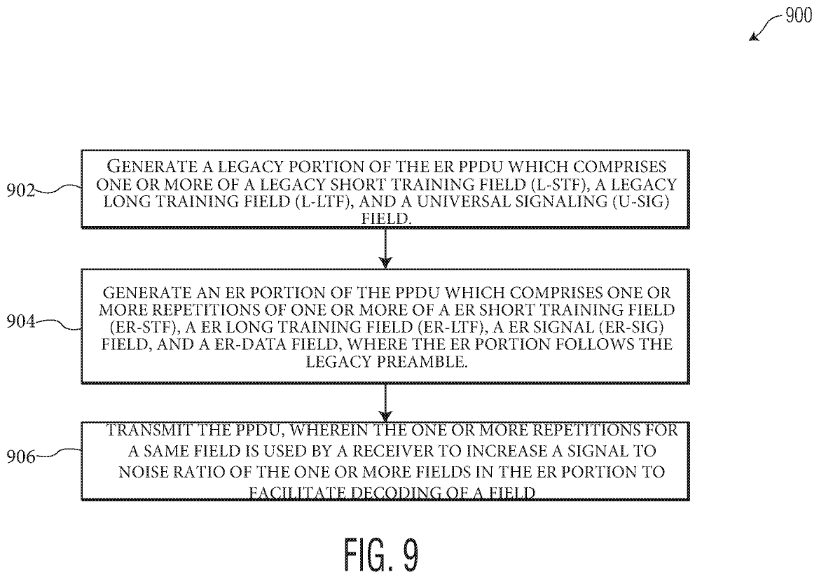

FIG. 9 is an example flowchart 900 that illustrates functions for generating an ER PPDU 200 for performing range extension in wireless communication in accordance with an embodiment. The functions may be performed by the range extension circuit 150 of a wireless device in an example. At 902, a legacy portion of the ER PPDU is generated which comprises one or more of a legacy short training field (L-STF), a legacy long training field (L-LTF), and a universal signaling (U-SIG) field. The legacy portion may be defined by IEEE 802.11be or 802.11ax in an example. If one wireless device transmits the PPDU and another wireless device is not able to receive and decode the legacy portion of the PPDU, then the other wireless device may attempt to decode an ER portion of the PPDU. At 904, an ER portion of the PPDU is generated which comprises one or more repetitions of one or more of a ER short training field (ER-STF), a ER long training field (ER-LTF), a ER-SIG (ER-SIG) field, and a ER data field, where the ER portion follows the legacy portion. In some examples, one or more transition symbols may be optionally added after U-SIG 210 and before the ER portion 204 to prepare a receiver to receive the ER portion 204 after receiving the legacy portion. The repetition of the ER portion may in be OFDM/A symbols repeated in time, in frequency of an OFDM/A symbol within a channel bandwidth, or both in time and in frequency. Further, in an example, the repetition of the ER-STF includes a polarity change of a waveform of the ER-STF and one or more of the ER-LTF, ER-SIG, and ER data fields is repeated in accordance with a dual carrier modulation with duplication (DCM+DUP) with a 106 tone, 52 tone, or 26 tone resource unit (RU) or RU repetition in a channel bandwidth. At 906, the PPDU and fields thereof is transmitted as a waveform or one or more waveforms, where the one or more repetitions for a same field is used to increase a signal to noise ratio of the one or more fields in the ER portion to facilitate decoding of the field. In an example, the repetition increases the SNR by greater than 3 dB by averaging signals associated with the repetitions.

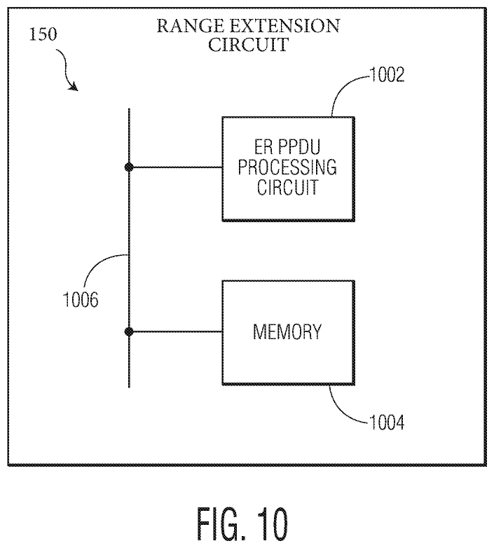

FIG. 10 is an example arrangement of the range extension circuit 150 which generates the ER PPDU 200 in accordance with an embodiment. The circuit 150 may be in the AP 102 or client device 126 and comprises an ER PPDU processing circuit 1002 (possibly including logic circuitry, hardware, multiple processors, multiple cores, multiple nodes, and/or implementing multi-threading, etc.) and memory 1004 such as system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more other possible realizations of non-transitory machine-readable media/medium. In some examples, the processing circuit 1002 may generate ER PPDU 200 as described herein and the memory 1004 may store computer code, program instructions, computer instructions, program code which is executable by the processing circuit 1002 for generating the ER PPDU 200. Interconnect 1006 such as a data bus may couple the processor 1002 and the memory 1004 and provide communication therebetween. The ER PPDU 200 is backward compatible with legacy WiFi and improve a communication range of uplink and downlink wireless communication to greater than 3 dB in an example when a client device is not able to detect a legacy portion.

In one embodiment, a method to transmit an extended range (ER) physical layer protocol data unit (PPDU) is disclosed. The method comprises: generating a legacy portion of the ER PPDU, the legacy portion comprising one or more of a legacy short training field (L-STF), a legacy long training field (L-LTF), a legacy signal (L-SIG field), and a universal signaling (U-SIG) field; generating an ER portion of the ER PPDU, the ER portion comprising one or more repetitions of a ER short training field (ER-STF), a ER long training field (ER-LTF), a ER-SIG (ER-SIG) field, and a ER data field, wherein the ER-STF is appended to the ER-LTF, the ER-LTF is appended to the ER-SIG field, the ER-SIG field is appended to the ER data field, and the ER portion follows the legacy portion; and transmitting the ER PPDU to a remote device over an air interface, wherein the one or more repetitions for a same field is used to increase a signal to noise ratio of a field received by a receiver. In an example, the repetition is a frequency domain repetition within a channel bandwidth and a time domain repetition in time. In an example, the frequency domain repetition of the ER-SIG field and ER-Data are one of a 106-tone dual carrier modulation (DCM) and Duplication (DCM+DUP) repetition and a 106-tone resource unit (RU) repetition spanning tones from [−122:−17 to 17:122] in the channel bandwidth. In an example, one or more pilot tones are located in a central 26-tone RU [−16:−4, 4:16]. In an example, the ER-STF is time domain repeated by repeating one or more waveforms of the ER-STF, wherein at least one of the waveforms is phase rotated. In an example, repetition of the ER-SIG field and ER-data field comprises interleaving tones or bits of the field in the one or more repetitions. In an example, generating the ER portion comprises time domain repeating the ER-LTF with one of a guard interval for each repetition and a guard interval for a only a first ER_LTF of a plurality of repetitions. In an example, the method further comprises: generating a transition symbol at the end of the legacy portion, wherein transition symbol causes the receiver to determine receiver time domain parameters based on a legacy universal signal (U-SIG) field decoding status. In an example, the repetition of one or more of the ER-SIG field and ER-data field comprises applying a phase rotation to tones of an resource unit defining the repetition.

In another example, an extended range (ER) physical layer protocol data unit (PPDU) is disclosed. The ER PPDU comprises: a legacy portion of the ER PPDU, the legacy portion comprising one or more of a legacy short training field (L-STF), a legacy long training field (L-LTF), a legacy signal (L-SIG) field, and a universal signaling (U-SIG) field; and an ER portion of the ER PPDU which follows the legacy portion, the ER portion comprising one or more repetitions of a ER short training field (ER-STF), a ER long training field (ER-LTF), a ER-SIG (ER-SIG) field, and a ER data field, wherein the ER-STF is appended to the ER-LTF, the ER-LTF is appended to the ER-SIG field, the ER-SIG field is appended to the ER data field, and the ER portion follows the legacy portion. In an example, the repetition is a frequency domain repetition within a channel bandwidth and a time domain repetition in time. In an example, the repetition of the ER-SIG field and ER-data field comprises interleaving tones or bits of the field in the one or more repetitions. In an example, the repetition of ER-LTF comprise one of a guard interval for each repetition and a guard interval for a only a first ER_ETF of a plurality of repetitions. In an example, the legacy portion has a same occupied bandwidth as the ER portion. In an example, bits of a binary sequence of the ER-LTF are set to zero if assigned to null subcarriers of a resource unit in a frequency domain repetition of the ER-LTF. In an example, bits of a binary sequence of the ER-LTF are not changed if assigned to null subcarriers of a resource unit in a frequency domain repetition of the ER-LTF. In an example, one or more of the ER-SIG field and ER data field is frequency domain repeated in one of a 242-tone resource unit (RU), 106-tone RU, 52-tone RU, and 26-tone RU, the repetitions spanning an entire channel band or a portion of the channel band. In an example, one or more of a binary sequence of the ER-SIG field and ER data field is frequency domain repeated in a channel bandwidth and time domain repeated. In an example, a subset of tones in the ER field on which bits of a binary sequence of a field is not loaded is loaded with pilot tones. In an example, the PPDU comprises a transition symbol between the legacy portion and ER portion to allow reset of time domain receive parameters of a receiver arranged to receive the PPDU.

A few implementations have been described in detail above, and various modifications are possible. The disclosed subject matter, including the functional operations described in this specification, can be implemented in electronic circuitry, computer hardware, firmware, software, or in combinations of them, such as the structural means disclosed in this specification and structural equivalents thereof: including potentially a program operable to cause one or more data processing apparatus such as a processor to perform the operations described (such as program code encoded in a non-transitory computer-readable medium, which can be a memory device, a storage device, a machine-readable storage substrate, or other physical, machine readable medium, or a combination of one or more of them).

While this specification contains many specifics, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

Other implementations fall within the scope of the following claims.

What is claimed is:

1. A method to transmit an extended range (ER) physical layer protocol data unit (PPDU), the method comprising:
generating a legacy portion of the ER PPDU, the legacy portion comprising one or more of a legacy short training field (L-STF), a legacy long training field (L-LTF), a legacy signal (L-SIG field), and a universal signaling (U-SIG) field;
generating an ER portion of the ER PPDU, the ER portion comprising one or more repetitions of a ER short training field (ER-STF), a ER long training field (ER-LTF), a ER-SIG (ER-SIG) field, and a ER data field, wherein the ER-STF is appended to the ER-LTF, the ER-LTF is appended to the ER-SIG field, the ER-SIG field is appended to the ER data field, and the ER portion follows the legacy portion; and
transmitting the ER PPDU to a remote device over an air interface, wherein the one or more repetitions for a same field is used to increase a signal to noise ratio of a field received by a receiver.

2. The method of claim 1, wherein the repetition is a frequency domain repetition within a channel bandwidth and a time domain repetition in time.

3. The method of claim 2, wherein the frequency domain repetition of the ER-SIG field and ER-Data are one of a 106-tone dual carrier modulation (DCM) and Duplication (DCM+DUP) repetition and a 106-tone resource unit (RU) repetition spanning tones from [422:47 to 17:122] in the channel bandwidth.

4. The method of claim 3, wherein one or more pilot tones are located in a central 26-tone RU [−16:−4, 4:16].

5. The method of claim 1, wherein the ER-STF is time domain repeated by repeating one or more waveforms of the ER-STF, wherein at least one of the waveforms is phase rotated.

6. The method of claim 1, wherein repetition of the ER-SIG field and ER-data field comprises interleaving tones or bits of the field in the one or more repetitions.

7. The method of claim 1, wherein generating the ER portion comprises time domain repeating the ER-LTF with one of a guard interval for each repetition and a guard interval for a only a first ER_LTF of a plurality of repetitions.

8. The method of claim 1, further comprising generating a transition symbol at the end of the legacy portion, wherein transition symbol causes the receiver to determine receiver time domain parameters based on a legacy universal signal (U-SIG) field decoding status.

9. The method of claim 1, wherein the repetition of one or more of the ER-SIG field and ER-data field comprises applying a phase rotation to tones of an resource unit defining the repetition.

10. An extended range (ER) physical layer protocol data unit (PPDU) comprising:
a legacy portion of the ER PPDU, the legacy portion comprising one or more of a legacy short training field (L-STF), a legacy long training field (L-LTF), a legacy signal (L-SIG) field, and a universal signaling (U-SIG) field; and
an ER portion of the ER PPDU which follows the legacy portion, the ER portion comprising one or more repetitions of a ER short training field (ER-STF), a ER long training field (ER-LTF), a ER-SIG (ER-SIG) field, and a ER data field, wherein the ER-STF is appended to the ER-LTF, the ER-LTF is appended to the ER-SIG field, the ER-SIG field is appended to the ER data field, and the ER portion follows the legacy portion.

11. The PPDU of claim 10, wherein the repetition is a frequency domain repetition within a channel bandwidth and a time domain repetition in time.

12. The PPDU of claim 10, wherein the repetition of the ER-SIG field and ER-data field comprises interleaving tones or bits of the field in the one or more repetitions.

13. The PPDU of claim 10, wherein the repetition of ER-LTF comprise one of a guard interval for each repetition and a guard interval for a only a first ER_ETF of a plurality of repetitions.

14. The PPDU of claim 10, wherein the legacy portion has a same occupied bandwidth as the ER portion.

15. The PPDU of claim 10, wherein bits of a binary sequence of the ER-LTF are set to zero if assigned to null subcarriers of a resource unit in a frequency domain repetition of the ER-LTF.

16. The PPDU of claim 10, wherein bits of a binary sequence of the ER-LTF are not changed if assigned to null subcarriers of a resource unit in a frequency domain repetition of the ER-LTF.

17. The PPDU of claim 10, wherein one or more of the ER-SIG field and ER data field is frequency domain repeated in one of a 242-tone resource unit (RU), 106-tone RU, 52-tone RU, and 26-tone RU, the repetitions spanning an entire channel band or a portion of the channel band.

18. The PPDU of claim 10, wherein one or more of a binary sequence of the ER-SIG field and ER data field is frequency domain repeated in a channel bandwidth and time domain repeated.

19. The PPDU of claim 10, wherein a subset of tones in the ER field on which bits of a binary sequence of a field is not loaded is loaded with pilot tones.

20. The PPDU of claim 10, wherein the PPDU comprises a transition symbol between the legacy portion and ER portion to allow reset of time domain receive parameters of a receiver arranged to receive the PPDU.
